(19) United States
(12) Patent Application Publication
(10) Pub. No.: US 2016/0338317 A1
(43) Pub. Date: Nov. 24, 2016

(54) ANIMAL'S CAGE HAVING RECIPROCATING DOOR

(71) Applicants: Gordon W.F. STROUD, Ontario (CA); Edward J.F. STROUD, Ontario (CA)

(72) Inventors: Gordon W.F. STROUD, Ontario (CA); Edward J.F. STROUD, Ontario (CA)

(21) Appl. No.: 15/157,856

(22) Filed: May 18, 2016

(30) Foreign Application Priority Data
May 20, 2015 (CA) 2 896 434

(51) Int. Cl. A01K 1/03

(52) U.S. Cl. CPC A01K 1/034

(57) ABSTRACT

The enclosure includes a stationary panel having a depression formed in one of its faces. An opening is formed in the depression. A door is inset in the depression and it too is provided with an opening. The door reciprocates from an open position in which the two openings are side by side one another to a closed position in which the openings are no longer side by side. When the door is open, a passage is opened from outside the enclosure to its interior through which an animal may enter and depart from the enclosure. When the door is closed, so also is the passage.

### FIELD OF THE INVENTION

This invention relates to an enclosure (sometimes referred to a “cage”) for animals and more particularly to an enclosure having a door which is simple to operate and optionally is provided with a latch free of troublesome components which are frequently found in latches in conventional enclosures for animals.

### CROSS-REFERENCE TO RELATED PRIOR APPLICATION

This application claims priority pursuant to 35 USC 119 of Canadian application no. 2,896,434 filed May 20, 2015 which application is incorporated herein by reference.

### BACKGROUND OF THE INVENTION

Enclosures for domestic animals such as cats and dogs usually have rectangular sides and end walls. One end wall usually opens and closes to give access to the interior of the enclosure. The material of the structure is usually strong cardboard or plastic so that its weight is not excessive. However being constructed of such material, the enclosure lacks the strength that it would have if it were constructed of stronger but heavier material such as metal and wood. Over time, enclosures constructed of cardboard or plastic and particularly those which are frequently used, begin to lose their shape or they crack with resulting loss of strength. The doors of such enclosures become harder o open and close and to remain reliably closed sufficient to prevent an animal from forcing it open and escaping from it.

Our invention includes a door for an enclosure or cage for a domestic animal with improved reliability. The door is easily opened and closed by means of a handle or a protuberance outside the structure and is easily detached for cleaning and easily reattached. As a result, dirt which accumulates inside an enclosure and which is often the cause of poor operation of the door can be easily' removed before it impedes the operation of the door.

Another problem frequently encountered in enclosures for animals is unreliable latches for the doors. The latches are frequently composed of one or more cylinders attached to either the door or the jamb of the structure. A pin which fits into the cylinder is attached to the other of these two components.

An animal in the enclosure can. cause the pin to misalign with a cylinder if it pushes hard against the walls of the structure adjacent to the latch since the walls, being composed of cardboard or plastic, have only limited strength. This is of course a problem which worsens as the weight of the animal increases or the more active the animal is in the enclosure.

Our invention includes a latch for the structure not consisting of a cylinder and a pin. The possibility of the door of the structure misaligning with the remainder of the structure is minimized despite the weight of the animal and the extent of its activity.

### SUMMARY OF THE INVENTION

Briefly, the enclosure of our invention according to one embodiment, includes a stationary panel having opposed faces and a depression formed in one face. A door is inset in the depression and when it is beside an opening in the depression and is open, a passage is opened from outside the enclosure to its interior through which an animal may enter and depart from the enclosure. The passage is closed when the opening in the door is no longer beside the opening in the depression.

According to another embodiment of the invention, the enclosure has both a rotatable door having an outer opening and an inner stationary panel having an inner opening. The stationary panel has a guide for directing the rotatable movement of the door from an open position in which the outer and inner openings are side by side one another o a closed position in which the two openings are no longer side by side. When side by side, a passage opens from the exterior of the enclosure to its interior while when the openings are no longer side by side, the passage is closed.

### DESCRIPTION OF THE DRAWINGS

The animal enclosure of our invention is described with reference to the accompanying drawings in which:

FIG. 1 is a perspective view of the animal enclosure;

FIG. 2 is an exploded perspective view of the front wall of the enclosure;

FIG. 3 is a perspective view of the assembled front wall;

FIG. 4 is a perspective view of a second embodiment of the front wall, a corner post and a latch of the enclosure;

FIG. 5 is a perspective view of the stationary panel and corner post from the side opposite that illustrated in FIG. 4; (The latch has been omitted.)

FIG. 6 is a perspective view of a latch for the door;

FIG. 7 is an elevation of the latch of FIG. 6 in an open position;

FIG. 8 is an elevation of the latch of FIG. 6 is a closed position;

FIG. 9 is an perspective view of latch together with the door and the corner post;

FIG. 10 is a plan view of a second embodiment of the latch;

FIG. 11 is a perspective view of a third embodiment of the door;

FIG. 11a is a section on line A-A in FIG. 11;

FIG. 11b is a fragmentary perspective view within the circle numbered B of FIG. 11;

FIG. 12 is a perspective view of a fourth embodiment of the door; and

FIG. 12a is a section on line B-B in FIG. 12.

Like reference characters refer like parts throughout the description of the drawings.

### DESCRIPTION OF PREFERRED EMBODIMENTS

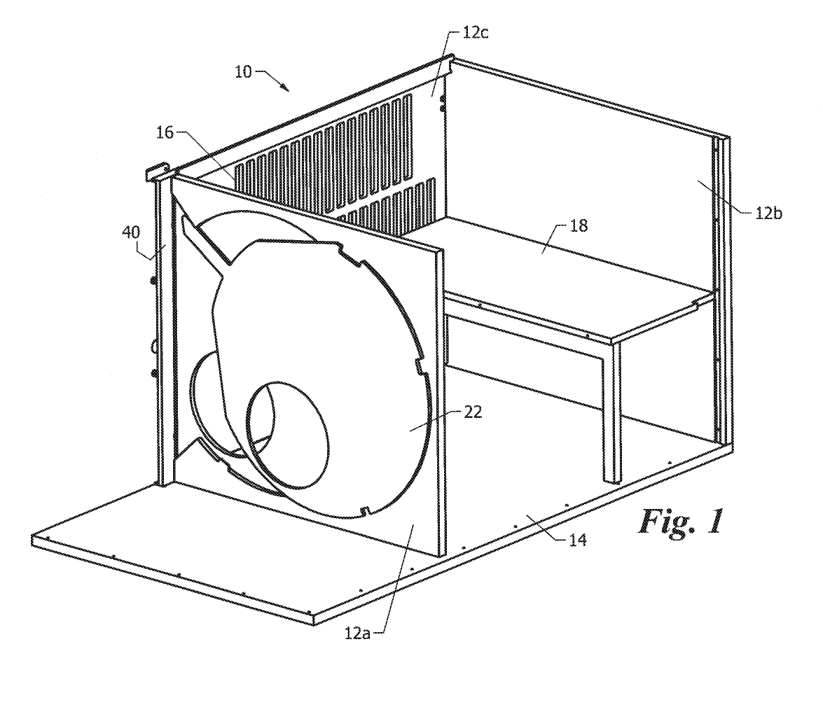

With reference to FIG. 1, the enclosure or cage of the invention consists of a structure provided with rectangular sides, generally 10, including front and back walls 12a, b, respectively, a left side wall 12c and a right side wall (not illustrated) opposite the left side wall. The enclosure also consists of a floor 14 and a ceiling (not illustrated) to form a fully enclosed structure. Wall 12c is provided with a grille 16 for ventilation but otherwise the wall consists of a solid panel of cardboard, plastic or other suitable material as do the remaining walls and the ceiling and the floor of the structure, save and except for front wall 12a which is described below. A shelf 18 is provided for an animal to rest upon.

In all respects the walls of the enclosure as well as the floor and ceiling, but with the exception of wall 12a, are conventional.

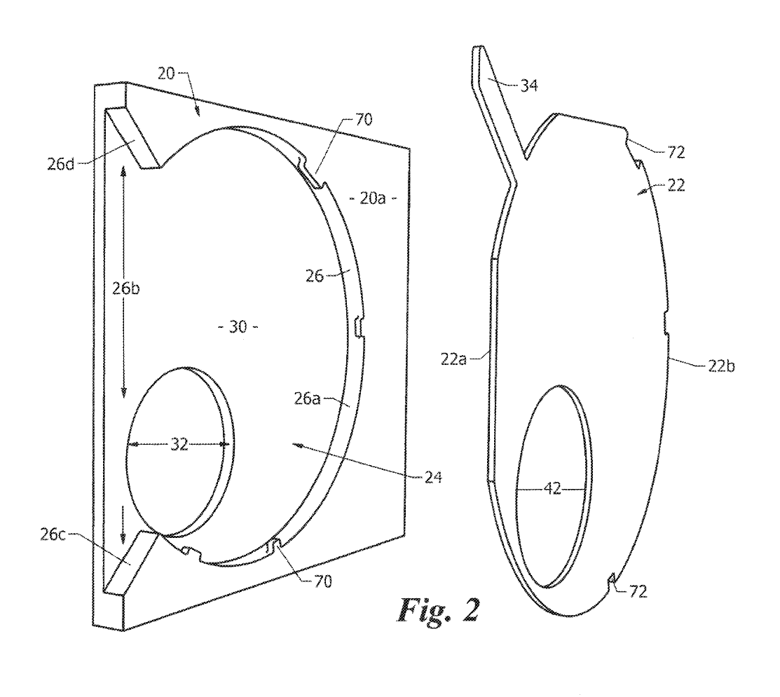

With reference to FIG. 2, wall 12a consists of a stationary panel, generally 20 and a reciprocating door, generally 22. The outer face 20a of the stationary panel is provided with a cavity or depression, generally 24, defined by an outer edge or periphery 26 at the edge of a solid base or floor 30.

The outer edge of the depression is partly arcuate in shape at area 26a, partly open at area generally 26b and partly straight at areas 26c and 26d. The straight areas define a stop for the door, as is explained below. An opening 32 is formed in the floor of the depression and it opens to the interior of the enclosure. That opening is referred to below as an “inner opening 32”.

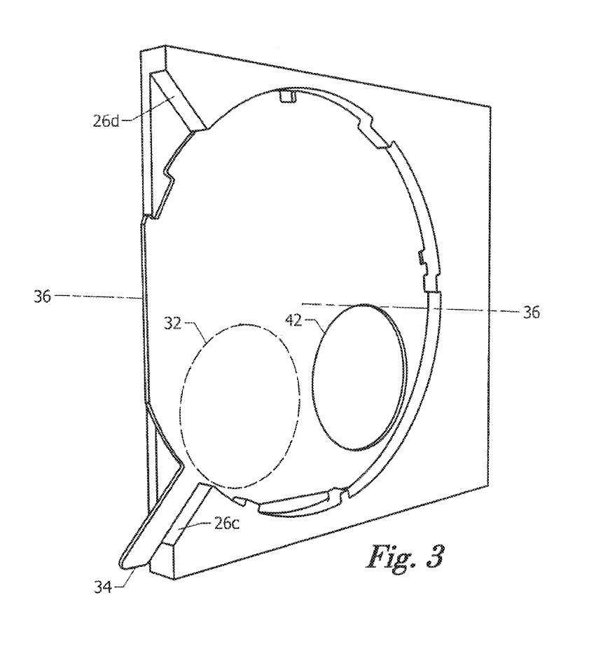

With reference to FIGS. 2 and 3, the floor of the depression provides a seat for door 22. The door has, at 22a, a straight outer edge and at 22b an arcuate outer edge or periphery of radius slightly less than the radius of the arcuate area 26a of the depression. When the door is inset into the depression so that the two arcuate areas are side by side and the door is free to turn in the depression without binding.

It should be noted that the door 22 depicted in FIG. 1 is outside the depression as it also is in FIG. 2, while in FIG. 3 it is inset into the depression.

With reference to FIGS. 2 and 3, the door is provided with a radially extending handle 34 which extends outside the enclosure as is explained below. When the handle is moved manually upward and downward is caused to reciprocate, it contacts first one straight area 26c and then the other area 26d of the side wall of the depression. The two straight areas accordingly act as stop points for the handle and the door and the open area 26b in the depression provides a space for the handle as is moves from one stop point to the other.

As the door reciprocates, the arcuate area 22b remains in contact with the like-shaped edge 26a of the depression. The latter edge functions as a guide for the door and causes it to reciprocate about a stationary axis 36-36. The door rotates clockwise and counterclockwise about the axis but does not move up and down or sideways in the depression.

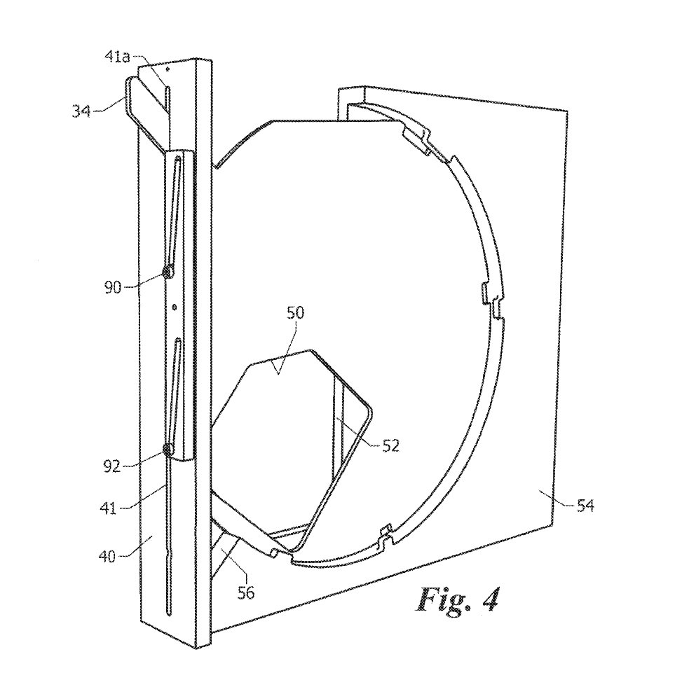

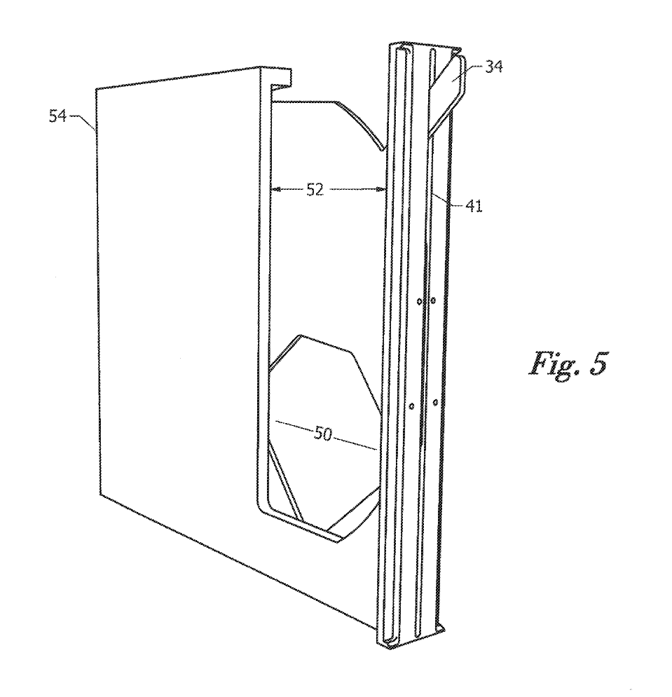

With reference to FIGS. 4 and 5, a vertical groove 41 is formed in a corner post 40 of the enclosure for receipt of the handle 34 so that the handle can be manipulated from outside the enclosure.

With reference again to FIG. 2 an outer circular opening 42 is formed in the door. This opening is referred to below as the “outer opening 42”. The opening is of the same diameter as that of the inner opening 22 in the stationary panel. As the handle moves from one stop point to the other, outer opening 42 aligns with inner opening 32 in one stop point. At the other stop point, the two openings are misaligned as illustrated in FIG. 3.

In FIGS. 4 and 5, outer opening 50 in the door is polygonal while the inner opening 52 in the stationary panel 54 is somewhat rectangular. The openings can be of any shape so long as the two openings are side by side one another when the handle is at one of the two stop points with resulting opening of a clear passage from the exterior of the enclosure to its interior. At the other stop point the passage is closed or blocked because the openings are no longer beside each other.

In FIG. 4, the openings are beside one another when the handle contacts the upper stop point and not beside each other as in FIG. 3 when the handle contacts the lower stop point. As will be observed at the upper stop point there is an open passage through the two openings for an animal to enter the enclosure or depart from it while at the lower stop point, the passage is closed.

It will also be observed in FIG. 4 that only one of the stop points, namely stop point 56 is a shoulder of the depression while the other stop point is defined by the upper edge 41a of the groove in the corner post.

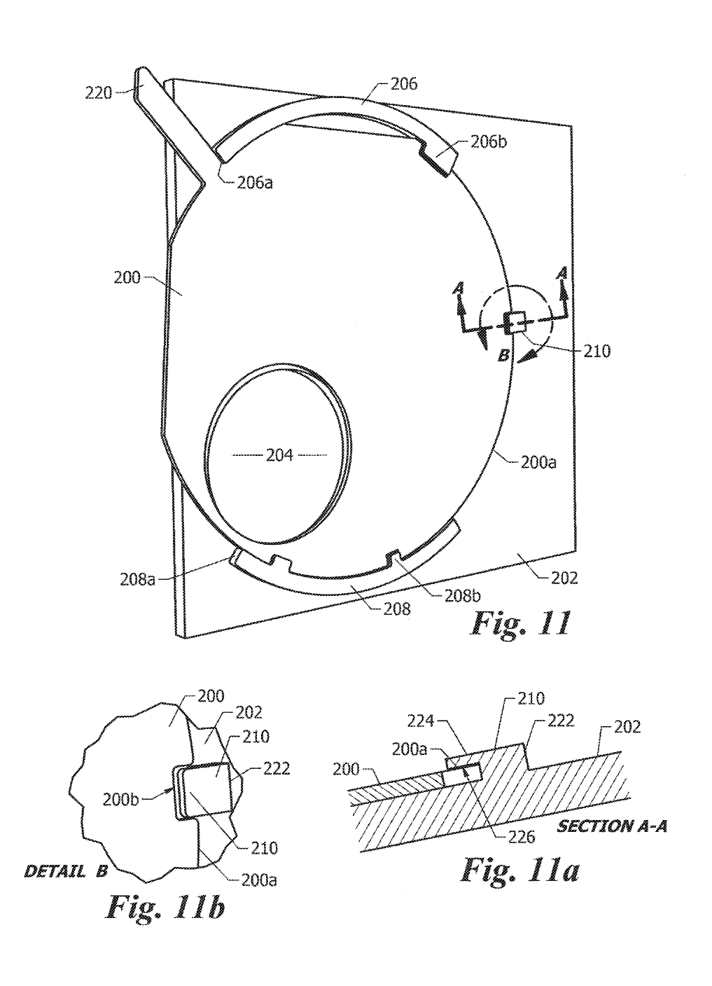

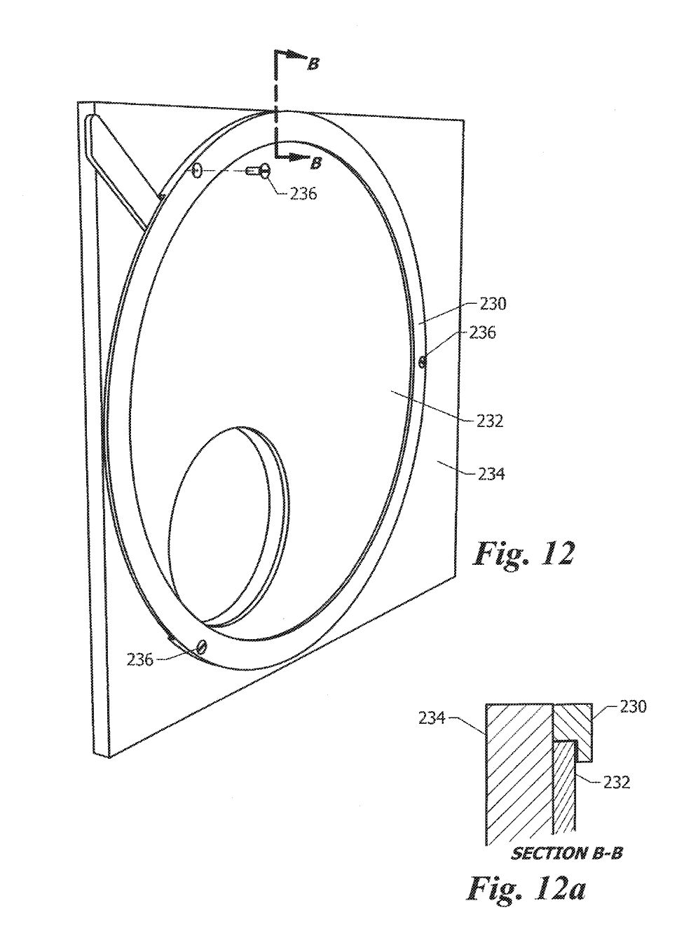

To summarize the foregoing, the door is open when the handle is at one stop point and the openings in the stationary panel and the door are in alignment (as in FIGS. 11 and 12) or are side by side (as in FIGS. 4 and 5) so that there is a clear passage from outside the enclosure to its interior. The door is closed when the handle is at the other stop point and the two openings are out of alignment or are no longer side by side.

In FIGS. 4 and 5 handle 34 is close to the upper stop point 41a and the openings are side by side one another. Downward movement of the handle causes the door to turn counterclockwise in FIG. 4, and. When viewed from the other side in FIG. 5, clockwise, with resulting closing of the door as the two openings move away from each other.

With reference again to FIG. 2, a number of tabs 70 are formed on the outer edge of the depression. The tabs are spaced apart from one another and serve to hold the door in the depression. A number of indentations 72 are formed in the outer edge of the door and the spacing of them is the same as the spacing of the tabs so that the door can be removed from the depression by rotating it until the tabs are aligned with the indentations.

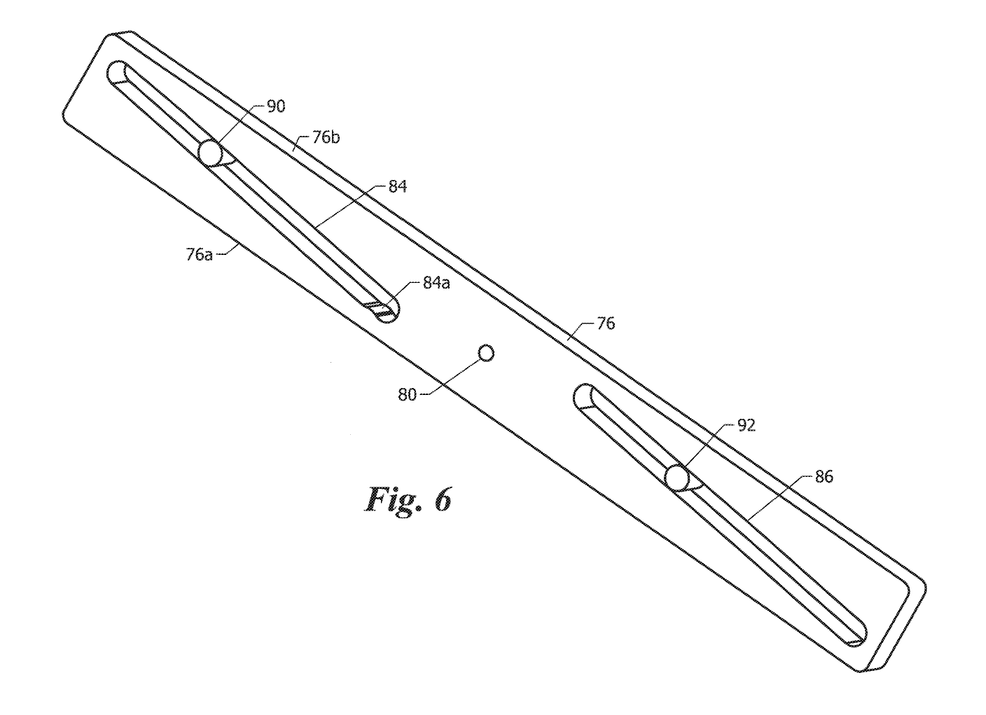

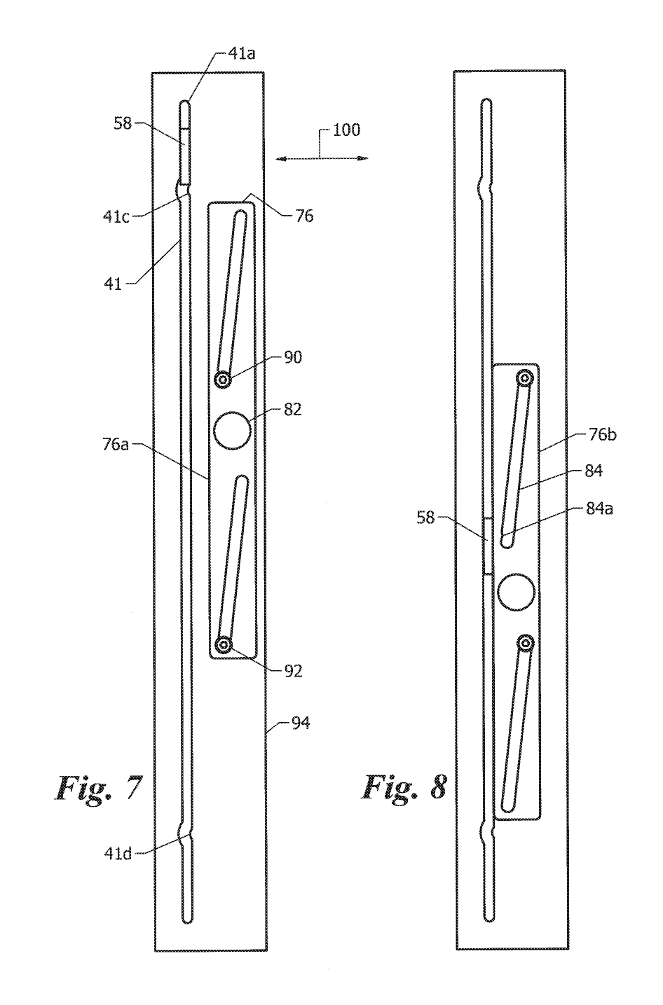

With reference to FIG. 6, a latch for immobilizing the handle of the door is illustrated. The latch consists of a bar 76 having elongated oppositely facing leading and trailing side edges 76a, 76b and a threaded opening 80 for receipt of a threaded pin of a knob 82 (FIG. 7) for manipulating the bar. Also formed in the bar is a pair of slots 84, 86. The slots are straight and parallel to one another and extend across the bar from adjacent to one side edge 76a to adjacent to the other side edge 76b.

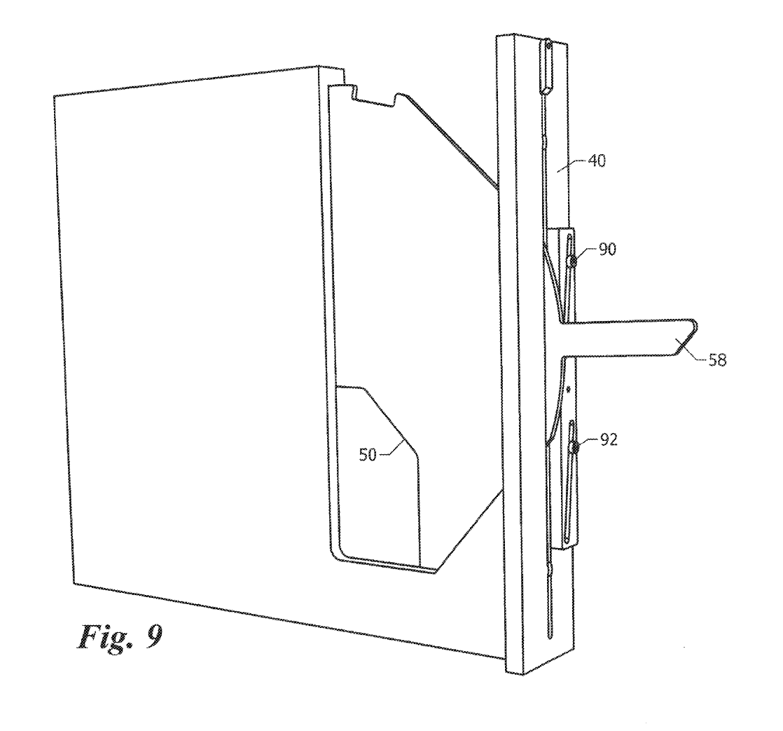

With reference to FIGS. 6 and 9, pins 90, 92 are affixed to the side wall of corner post 40 of the enclosure and project through slots 84, 86, respectively, in the latch. The pins are located in the same place in each slot. The pins and the angle of the slots are located to guide the bar as it slides along the corner post in the manner descried below.

With reference to FIGS. 7 and 8, as bar 76 slides, its side edges 76a, b remain parallel to the longitudinal axis of groove 41 but, because of pins 90, 92, move laterally in the direction of arrow 100, In the position illustrated in FIG. 7, the leading edge 76a is spaced apart from groove 41 and the handle 58 is free to reciprocate in the groove. In FIG. 8 the leading edge presses against handle 58 and immobilizes it.

Detents 41c, 41d are provided in the groove adjacent to its upper and lower ends respectively to prevent the handle from accidentally moving from its intended position. The upper detent 41c prevents the handle from descending with resulting closing of the door. The lower detent prevents the latch from accidentally being raised and the door opening.

With reference to FIG. 6, a detent 84a is also formed in the the upper groove to prevent the latch from accidentally moving when it has been placed in the intended position.

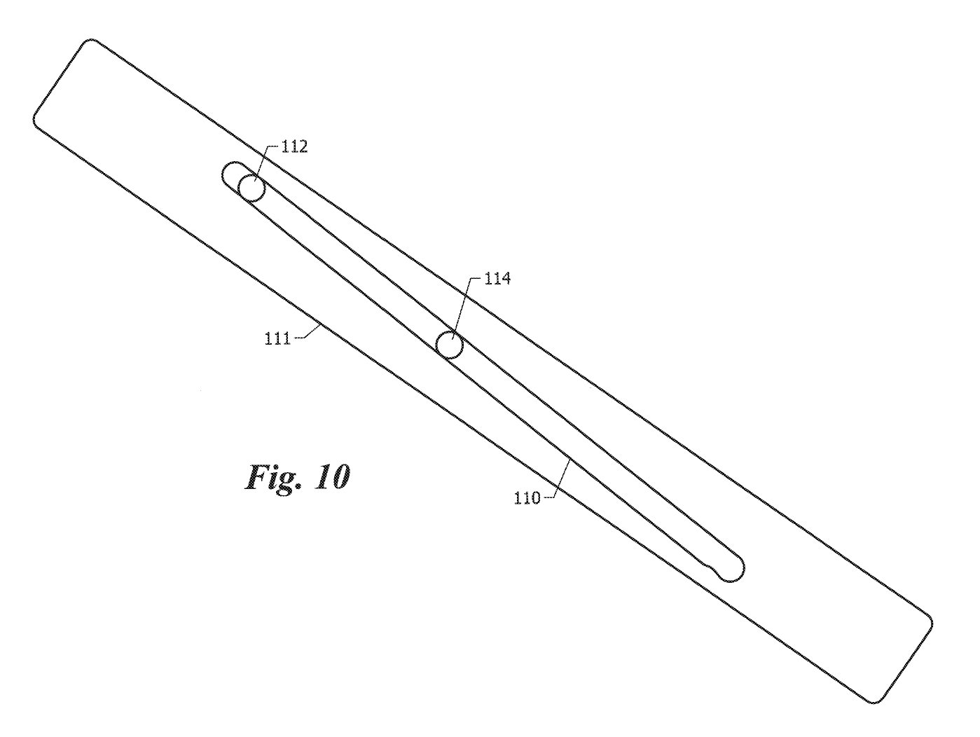

in FIG. 10 only one slot 110 is formed in bar 111 and two pins 112 and 114 are accommodated within it. The pins are located and the slot is angled so that bar 111 operates in the same way as bar 76 of FIGS. 6-8.

With reference to FIG. 11, door 200 is the same as the door of FIG. 2 but the stationary panel 202 is flat throughout its extent except for an opening 204 illustrated as aligned with the opening in the stationary panel for ingress and egress from the enclosure (not illustrated). No depression is formed in the stationary panel.

Upper and lower guide members 206, 208 are arcuate in shape while guide 210 is rectangular but their cross-sections, illustrated in FIG. 11 a are all the same. The guide members function to control the rotational movement of the door. The end walls 206a, 208a function as stops points for handle 220 of the door.

With reference to FIG. 11a, each guide member consists of a base 222 which projects outward from the stationary panel and a retainer 224 which extends from the base over the peripheral edge 200a of the door. The peripheral edge is not shown in FIG. 11a because there is an indentation or notch at that location in the door beneath retainer 210. The indentation is numbered 200h in FIG. 11b. Additional indentations are beneath tabs 206b, 208b in guide members 206, 208.

Retainer 224, in conjunction with the portion of the stationary panel beneath the retainer, define a groove 226 which accommodates the peripheral edge of the door.

In FIG. 12 the guide member is a ring or annulus 230 having a cross-section illustrated in FIG. 12a, Otherwise the door 232 and stationary panel 234 are the same as those depicted in FIG. 11.

The doors of FIG. 11 can be removed for cleaning in the same manner as door 2. FIG. 2. The door of FIG. 12 can be removed by removal of screws 236.

It will be understood of course that modifications can be made in the structure of the al enclosure described herein without departing from the scope and purview of the invention as defined in the appended claims.

We claim:

1. An enclosure for an animal including a stationary panel having opposed faces and a depression formed in one said face, said depression having an inner opening formed therein; a door having an outer opening and being inset into said depression, said door when so inset adapted to reciprocate between an open position and a closed position, said inner and outer openings when said door is in said open position being in a side-by side relationship with one another and defining an open passage into and out of said enclosure through which an animal may enter and depart from said enclosure, and when said inner and outer openings are no longer in a side-by-side relationship, said door is in said closed position and prevents said animal from entering and departing from said enclosure.

2. The animal enclosure of claim 1 wherein said depression is defined by an outer edge and said door has an arcuate peripheral edge in contact with said circular edge as said door reciprocates.

3. The animal enclosure of claim 2 wherein said door reciprocates about a horizontal axis.

4. The animal enclosure of claim 2 further including means for preventing said door from separating from said depression.

5. The animal enclosure of claim 4 wherein said means for preventing separation is a plurality of tabs which extend radially inward from said outer edge of said depression and a plurality of indentations formed on said peripheral edge of said door, said indentations being positioned to periodically align with said tabs as said door reciprocates, said tabs when so aligned with said indentations allowing said door to be removed from said depression.

6. The animal enclosure of claim 1 wherein said door has a handle which travels in a groove as said door reciprocates, said enclosure including: a latch disposed adjacent to said groove; and a pair of spaced apart stationary guide pins, said latch having a bar provided with a slot for accommodation of both said guide pins and being slidable relative to said guide pins in a direction determined by said guide pins and by the orientation of said slot, said bar having oppositely facing leading and trailing side edges, said leading edge being dis-posed adjacent to said groove, the position of said guide pins and the orientation of said slot being arranged such that as said bar slides in one direction, said leading edge advances into contact with said handle and immobilizes said handle and as said bar slides in the opposite direction, said leading edge retreats from said groove thereby allowing free movement of said handle in said groove.

7. The animal enclosure of claim 1 wherein said door has a handle which travels in a groove as said door reciprocates, said enclosure including: a latch disposed adjacent to said groove; and a pair of spaced apart stationary guide pins which extend outwardly from said side wall, said latch comprising a bar having a pair of slots for accommodation of said guide pins, one said guide pin being accommodated in one said slot while the other said guide pin being accommodated in the other said slot, said bar being slidable relative to said guide pins in a direction determined by said guide pins and by the orientation of said slots, said bar having oppositely facing leading and trailing side edges, said leading edge being disposed adjacent to said groove, the position of said guide pins and the orientation of said slots being arranged such that as said bar slides in one direction, said leading edge advances into contact with said handle and immobilizes said handle and as said bar slides in the opposite direction, said leading edge retreats from said groove thereby allowing free movement of said handle in said groove.

8. An enclosure for an animal including: a rotatable door having an outer opening formed therein; a stationary panel having opposed faces and an inner opening formed therein, said stationary panel having a guide for directing the rotatable movement of said door from an open position in which said outer and inner openings are in a side-by-side relationship to a closed position in which said outer and inner openings are no longer side-by-side, said inner and outer openings when side-by-side providing a passage into and out of said enclosure through which an animal may enter and depart from said enclosure, and when said inner and outer openings are no longer side-by-side, said door prevents said animal from entering and departing from said enclosure.

9. The animal enclosure of claim 8 Wherein a depression is formed in one said face of said stationary panel, said depression being defined by an outer edge, said door being inset into said depression, said door having a peripheral edge, a portion of which contacts a portion of said outer edge and wherein said guide consists of said outer edge portion which directs the movement of said door.

10. The animal enclosure of claim 8 wherein said door has a peripheral edge and wherein said guide consists of a plurality of protuberances on said face of said stationary panel, said protuberances each having a groove for accommodation of said peripheral edge.

11. The animal enclosure of claim 8 wherein said door has a peripheral edge and said guide is an annulus which overlies said door, said annulus having a groove for accommodation of said peripheral edge, said door being rotatable relative to said annulus and to said stationary panel
